(19) United States
(12) Patent Application Publication
(10) Pub. No.: US 2018/0195286 A1
(43) Pub. Date: Jul. 12, 2018

(54) Polymer Shingles

(71) Applicant: James Douglas Fletcher, Miami, NC (US)

(72) Inventor: James Douglas Fletcher, Miami, NC (US)

(21) Appl. No.: 15/870,736

(22) Filed: Jan. 12, 2018

Related U.S. Application Data
(60) Provisional application No. 62/498,966, filed on Jan. 12, 2017.

(51) Int. Cl. E04D 1/28; B32B 5/02; B32B 5/16; B32B 27/08; B32B 27/12; B32B 27/14; B32B 27/20; B32B 5/26; B32B 37/24; E04D 5/10

(52) U.S. Cl. CPC E04D 1/28; E04D 2001/005; B32B 5/16; B32B 27/08; B32B 27/12; B32B 27/14; B32B 27/20; B32B 5/26; B32B 37/24; E04D 5/10; B32B 2264/107; B32B 2307/3065; B32B 2307/7265; B32B 2419/06; B32B 5/022

(57) ABSTRACT

The present invention discloses about polymer shingles used as a roofing sheet or a waterproof membrane comprises a felt of a particular characteristic and of different thicknesses for providing strength to the shingles as per consumers specific needs. One or more layers of polymer and primer is applied on the felt, thereby facilitating bonding of the several layers of the shingles. Further cement additives such as Portland cement or calcium cement additive are selectively used depending on the quality of the shingle that is required to manufacture the polymer shingles to act as waterproof membrane. Further, applying ceramic granules onto the cement additive and are then compressed with a roller to ingrain them in the polymer layer to be used a weather proof and durable roofing sheet.

### CROSS-REFERENCES TO RELATED APPLICATIONS

This application claims priority from U.S. Provisional Application Ser. No. 62/498,966, entitled “Polymer Shingles”, filed on Jan. 12, 2017, which application is hereby incorporated herein by reference in its entirety for all that it discloses for all purposes.

### FIELD OF THE INVENTION

The present invention relates generally to roofing sheets and waterproof membranes made for shingles. More so, the present invention relates to roofing sheets and waterproof membranes made for polymer shingles and waterproof geo-membranes and a method of its manufacturing.

### BACKGROUND OF THE INVENTION

Clay shingles have been used for over 5000 years, beginning with the Babylonians and subsequently their use spread to other parts of the world; at that time, the predominant roofing material where stone shingles and straw. In 1840's asphalt shingles were developed using a felt or woven fabric combined with a tar-like emulsion, thus they became the predominant shingles used in the roofing market. In 1915, as industrial technologies improved, stone shingles benefited from continuous production line methodologies thus manufacturing times where shortened and increased levels of production where attained. In 1970, fiberglass shingles were introduced to the roofing market while other types of shingles including fake slate shingles, slate shingles and metal shingles were developed in the 1980s.

There is a myriad of problems with such prior art shingles. These problems run the gamut from high manufacturing costs which are ultimately paid by the consumer at the retail level, to high energy consumption as a consequence of production and low life expectancy thus a higher need for maintenance and/or replacement.

Clay shingles tend to be expensive to manufacture and are somewhat fragile when exposed to the elements (hail, windstorm, tremors, etc). Laying and securing them to the roof is time consuming, are not very resistant to pressure loads. Stone (slate) shingles are heavy, difficult to secure, their production is very slow, tedious and therefore expensive.

In the last three decades, asphalt shingles have not improved correspondingly with the technological improvements in the manufacturing sphere. They are affected by UV light, have a high CO² foot print in its manufacturing process due to the heavy use of fossil fuels, thus not totally eco-friendly. With extreme temperature changes (from very cold to very hot) their life expectancy is reduced and wear out very fast. They also become brittle under UV light exposure. An additional problem is that as weather conditions vary the asphalt shingles expand and contract, filtration issues arise in the gap between the nail and the shingle; this in turn affects the integrity of the roof and wall structure. Their removal and replacement cost are high after 20 to 25 years of use.

Metal shingles have a high production cost, their effectiveness in insulating is a matter of concern, have a high CO² foot print, thus, not eco-friendly at least in part because metals are produced through melting at high temperatures resulting in high electricity consumption during the lamination process. An additional concern is also the noise they generate when exposed to inclement weather. Hail can be a problem since the roof can become warped or distorted due to the impact.

Numerous innovations have been provided in prior art designs that are adapted to roof shingles and their method of manufacturing. Even though these innovations may be suitable for the specific purposes to which they address they would not be as suitable for the purposes of the present invention.

For example, U.S. patent application Ser. No. 12/151,367 to Wollert et al. discloses a rolled sheet roofing membrane comprises an elastomeric top layer and an asphalt bottom layer, wherein the roofing membrane further comprises ceramic coated granules located between an asphalt layer and the elastomeric top layer.

U.S. patent application Ser. No. 11/906,217 to Furgal et al. teaches a roofing membrane comprising a base reinforcement layer, a top reinforcement layer bonded to the base reinforcement layer, and a polymeric coating the top reinforcement layer bonded to the base reinforcement layer.

U.S. Pat. No. 7,125,601 to Pinault et al. teaches an integrated granule product bonded to a roofing material substrate, wherein said integrated granule product comprises a film having a plurality of ceramic coated granules bonded with a cured adhesive.

U.S. Pat. No. 3,937,640 to Tajima describes a self-adhesive type multi-layer laminated bituminous waterproof roofing membrane comprising a base sheet coated with one or more bitumen layers.

U.S. patent application Ser. No. 13/723,473 to Shiao et al. teaches a roofing product, comprising: a substrate; and roofing granules on the substrate configured to perform a water filtering function, the roofing granules having a porous composite structure comprising a UV-opaque core and a water filtering layer on the UV-opaque core.

U.S. patent application Ser. No. 12/990,458 to Stephens et al. teaches a shingle and a method of roofing using a plurality of the shingles, wherein the shingle comprises an upper surface comprising an attachment area and an exposed area having a polyvinylidene fluoride a reflective coating and an inking.

It is apparent now that numerous innovations for a roof shingles and waterproof membranes have been developed in the prior art that are adequate for various purposes. Furthermore, even though these innovations may be suitable for the specific purposes to which they address, accordingly, they would not be suitable for the purposes of the present invention as heretofore described. Thus, to overcome the shortcomings, the present invention provides roof shingles and waterproof membranes to mitigate the aforementioned problems.

### SUMMARY OF THE INVENTION

Some of the objects and advantages of the invention will now be set forth in the following description, while other objects and advantages of the invention may be obvious from the description, or may be learned through practice of the invention. Broadly speaking, the present invention discloses a roofing sheet and a waterproof sheet defining polymer shingles and the method of preparing same.

The polymer shingles and the waterproof membrane of the present invention uses a felt (non-woven textile fabric) of a particular characteristic and of different thicknesses for providing strength to the shingles and to the membrane as per consumers specific needs. A polymer primer is applied on the felt, thereby allowing additional polymer applications to bond. Further cement additives such as Portland cement or calcium cement additive are selectively used depending on the quality of the shingle that is required. Ceramic granules are then applied on to the cement additive and are compressed with a roller to ingrain them in the polymer layer.

According to an aspect of the present invention, a roofing sheet comprises a non-woven textile fabric (however any other suitable type of fabric can be used without departing from the scope and spirit of the present invention), a first layer comprising felt adhered to the non-woven textile fabric to form a non-woven geo-textile fabric. Alternatively, the non-woven textile fabric may be a felt layer. A second layer comprising primer mixed with fire and flame resistant additives adhered over the non-woven geo-textile fabric; a third layer comprising a polymer mixed with fire and flame resistant additives and cement additives adhered over the second layer; a fourth layer comprising a polymer mixed with fire and flame resistant additives and cement additives adhered over the third layer and a top layer comprising ceramic granules mixed with fire and flame resistant additives and cement additives, wherein the ceramic granules are bonded using a cement additive adhered to the fourth layer, further the granules are compressed with a roller to ingrain the granules in the polymer; wherein desired color pigments can be added to the primer of the second layer, polymer mix of the third and fourth layer and additives of the top layer to have desired coloring of the roofing sheet.

According to another aspect of the present invention, a waterproof membrane comprising, a non-woven textile fabric; a first layer comprising felt adhered to the non-woven textile fabric to form a non-woven geo-textile fabric; a second layer comprising primer mixed with fire and flame resistant additives adhered over the non-woven geo-textile fabric; a third layer comprising a polymer mixed with fire and flame resistant additives and cement additives adhered over the second layer; and a fourth layer comprising a polymer mixed with fire and flame resistant additives and cement additives adhered over the third layer; and a top layer comprising cement additives comprising calcium cement or portland cement, wherein desired color pigments can be added to the primer of the second layer, polymer mix of the third and fourth layer and additives of the top layer to have desired coloring of the waterproof membrane.

In view of the foregoing, it is therefore an object of the present invention is to provide a polymer shingle that can act as a roofing sheet.

Another objective of the present invention is to provide a polymer geo-textile membrane that can act as a waterproof membrane.

Another objective is to provide polymer shingles comprising a non-woven textile fabric, a felt layer, a primer layer, two polymer layers, and a layer of ceramic granules adhered to the top surface of the shingles.

Yet another objective is to provide polymer shingles and a polymer textile fabric, that act as waterproof membranes comprising a non-woven textile fabric, a felt layer, a primer layer, two polymer layers, and a layer of cement additives.

Another objective is to provide polymer shingles added with desired color pigments that can be added to the primer layer, polymer mix and cement additives layer to have desired coloring of the waterproof membrane and the roofing sheet.

Yet another objective is to provide environment friendly polymer shingles that provide high resistant to abrupt changes in weather and temperature conditions.

Yet another objective is to provide polymer shingles that are fire resistant.

Yet another objective is to provide polymer shingles that are resistant to UV (Ultraviolet) ray exposure.

Yet another objective is to provide polymer shingles having high tensile strength and thus can provide good stretch and are highly flexible.

Yet another objective is to provide polymer shingles that are resistant to fracture and are easy to repair.

Yet another objective is to provide polymer shingles that are resistant to alkaline and acid.

Yet another objective is to provide polymer shingles that are low cost, and easy to manufacture.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description). Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 illustrates cross sectional view the polymer shingles showing different layers of the polymer shingles for manufacturing roofing sheets, in accordance with an embodiment of the present invention;

FIG. 2 illustrates cross sectional view the polymer shingles showing different layers of the polymer shingles for manufacturing waterproof membrane, in accordance with an embodiment of the present invention;

FIG. 3 illustrates a flow chart showing a method of manufacturing polymer shingles for roofing sheet, in accordance with an embodiment of the present invention; and

FIG. 4 illustrates a flow chart showing a method of manufacturing polymer shingles for preparing a waterproof membrane, in accordance with an embodiment of the present invention.

Repeat use of reference characters throughout the present specification and appended drawings is intended to represent the same or analogous features or elements of the present technology.

### DETAILED DESCRIPTION OF THE INVENTION

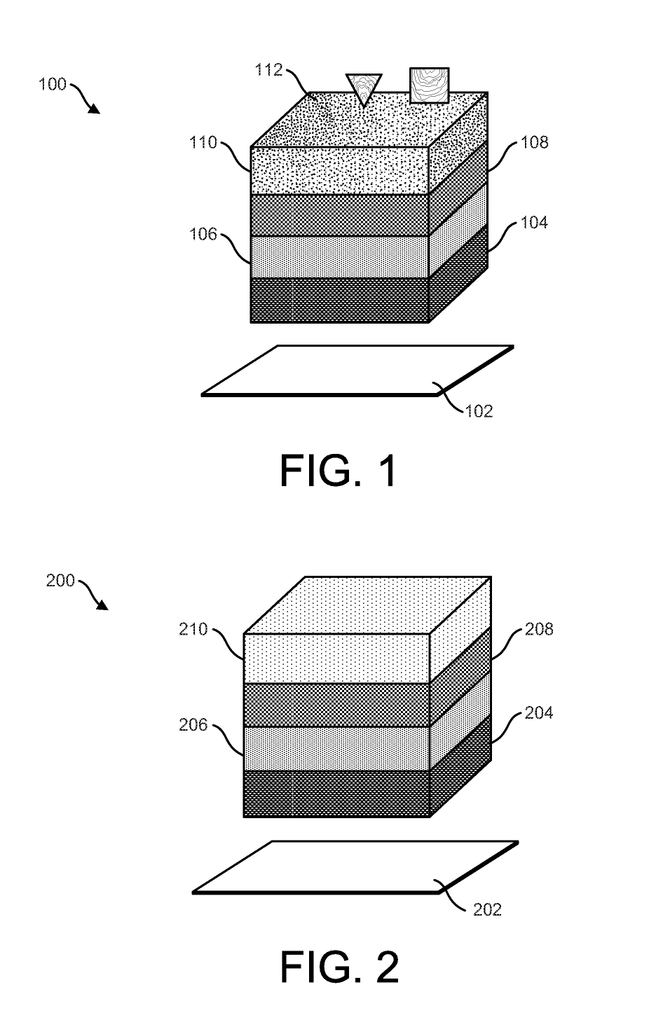

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “side,” “front,” “perspective,” and derivatives thereof shall relate to the invention as oriented in FIGS. 1-4. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise. Each example is provided by way of explanation of the invention, not limitation of the invention and it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps.

### Construction Aids

For the purposes of this document two or more items are “mechanically associated” by bringing them together or into relationship with each other in any number of ways including a direct or indirect physical connection that may be intended to be releasable (e.g. snaps, rivets, screws, bolts, etc.) and connections that not intended to be easily disconnected such as (e.g. welding, sowing, gluing, bonding etc.) and connections that are intended to be movable (e.g. rotating, pivoting, oscillating, etc.). For example, items that are merely “mechanically associated” are broader embodiments of items that are “mechanically associated using bolts”.

For the purposes of this document, unless otherwise stated, the phrase “at least one of A, B, and C” means there is at least one of A, or at least one of B, or at least one of C or any combination thereof (not one of A, and one of B, and one of C).

This document includes headers that are used for place markers only. Such headers are not meant to affect the construction of this document and are not in any way related to the meaning of this document nor should such headers be used for such purposes.

In this document, “about” means plus or minus 20% unless stated otherwise.

### Description

One exemplary embodiment of the present invention discloses polymer shingles or polymer membrane (100, 200) and their manufacturing method to act as a roofing sheet or a waterproof membrane. The polymer shingles (100, 200) of the present invention uses a felt (non-woven textile fabric) of a particular characteristic and of different thicknesses for providing strength to the shingles as per consumer's specific needs. A polymer primer is applied on the felt, thereby allowing additional polymer applications to bond. Cement additives, such as Portland cement or calcium cement additives, are selectively used depending on the quality of the shingle that is required. Ceramic granules are then applied onto the cement additive and are compressed with a roller to ingrain them in the polymer layer.

Referring now to FIG. 1, one exemplary embodiment of the present invention is presented showing a cross-sectional view of the different layers of exemplary polymer shingles 100. According to one aspect of the present invention a roofing sheet comprising a non-woven textile fabric (102) is associated with five layers of material. The first layer comprises a textile material such as felt which is adhered to the non-woven textile fabric (102) having a predetermined configuration to form a non-woven geo-textile fabric. Alternatively, the non-woven textile fabric may be felt so that the entire shingle is only 5 layers. A second layer (104), comprising primer optionally mixed with fire and flame resistant additives, is adhered over the non-woven geo-textile fabric (102). Similarly, a third layer (106), comprising a polymer mixed (polymer layer) with fire and flame resistant additives and cement additives is adhered over the second layer (104). A fourth layer (108) also comprising a polymer mixed with fire and flame resistant additives and cement additives is adhered over the third layer (106). One of ordinary skill in the art will note that the third and fourth layers are similar or identical. The reason two layers are used instead of one thicker is to keep the individual layers as thin as possible. Such a configuration allows the polymer shingles (100) to be flexed without damaging the shingle. It should be appreciated that at least. Using this method five polymer layers can be used if desired. A top layer comprising ceramic granules mixed with fire and flame resistant additives and cement additives, wherein the ceramic granules are bonded using a cement additive, is adhered to its adjacent layer, which for this embodiment is the fourth layer (108). Preferably, the granules are compressed with a roller to ingrain the granules in the polymer of the previous layer. Color pigments can be added to any of (a) the primer of the second layer, (b) polymer mix of the third layer, (c) the polymer mix of the fourth layer and (d) the additives of the top layer to achieve a desired coloring for the roofing sheet. For the preferred embodiment, such color pigments are added to all such layers. Further, the color pigments may be different colors for different layers.

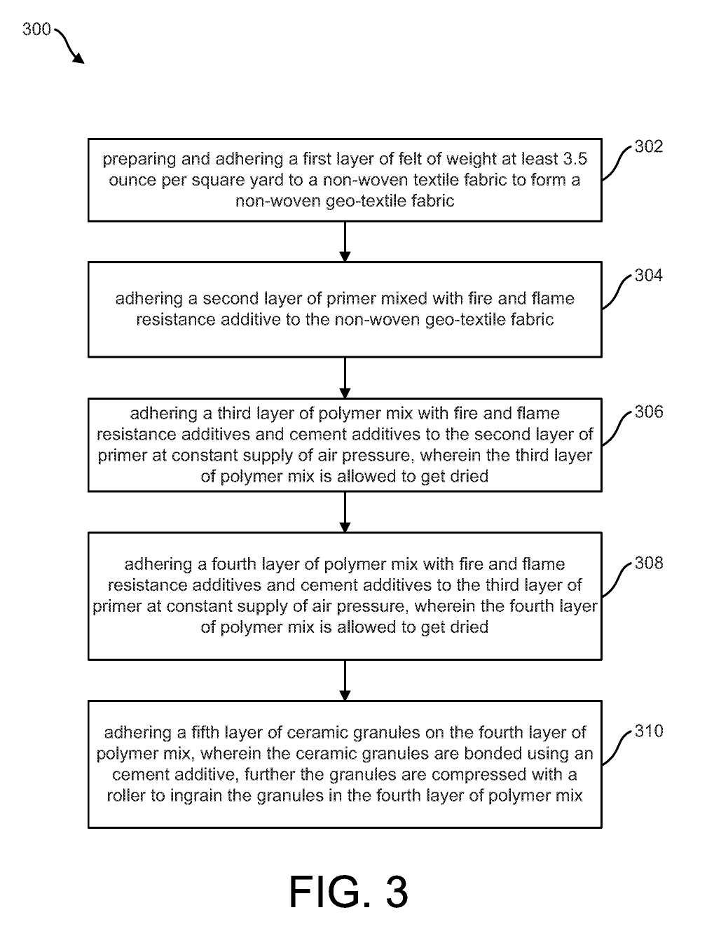

Referring now to FIG. 3, one exemplary process and method for making the above described polymer shingles (100) is presented. At step 302, a first layer of felt is prepared and adhered to a non-woven textile fabric to form a non-woven geo-textile fabric. Alternatively, the first lawyer is a felt layer. Preferably, the felt layer has a weight of about 3.5 ounces per square yard to create a non-woven geo-textile fabric of about 3.5 to 5.15 ounce per square yard depending on the embodiment. At step 304 a second layer of primer mixed with fire and flame resistant additives is adhered to the non-woven geo-textile fabric. Next, at stop 306, a third layer of polymer mix with fire and flame resistant additives and cement additives is adhered to the second layer of primer, preferably at constant supply of air pressure, wherein the third layer of polymer mix is allowed to dry before the next layer is added. At step 308 a fourth layer of polymer mix with fire and flame resistant additives and cement additives is adhered to the third layer at constant supply of air pressure and allowed to dry before adding the next layer. It will be appreciated that up to five polymer layers may be used depending in the intended purpose and thinness desired. Next, a top layer is created by adhering ceramic granules onto the fourth layer of polymer mix, wherein the ceramic granules are preferably bonded using a cement additive. The granules may be compressed with a roller to ingrain the granules in the fourth layer of polymer mix. If desired, color pigments can be added to any one of the primer of the second layer, polymer mix of the third and fourth layer and the additives of the top layer to achieve a desired coloring of the roofing sheet.

According to yet another aspect of the present invention, a waterproof membrane is considered. For such embodiment, a non-woven textile fabric is mechanically associated with a first layer comprising felt to form a non-woven geo-textile fabric. A second layer comprising primer mixed with fire and flame resistant additives is adhered over the non-woven geo-textile fabric. A third layer (polymer layer) comprising a polymer mixed with fire and flame resistant additives and cement additives is adhered over the second layer and a fourth layer comprising a polymer mixed with fire and flame resistant additives and cement additives adhered over the third layer. A top layer comprises cement additives, such as calcium cement and/or portland cement. Color pigments can be added to any one of the primer of the second layer, the polymer mix of the third and fourth layer, and the additives of the top layer to define a desired coloring of the waterproof membrane.

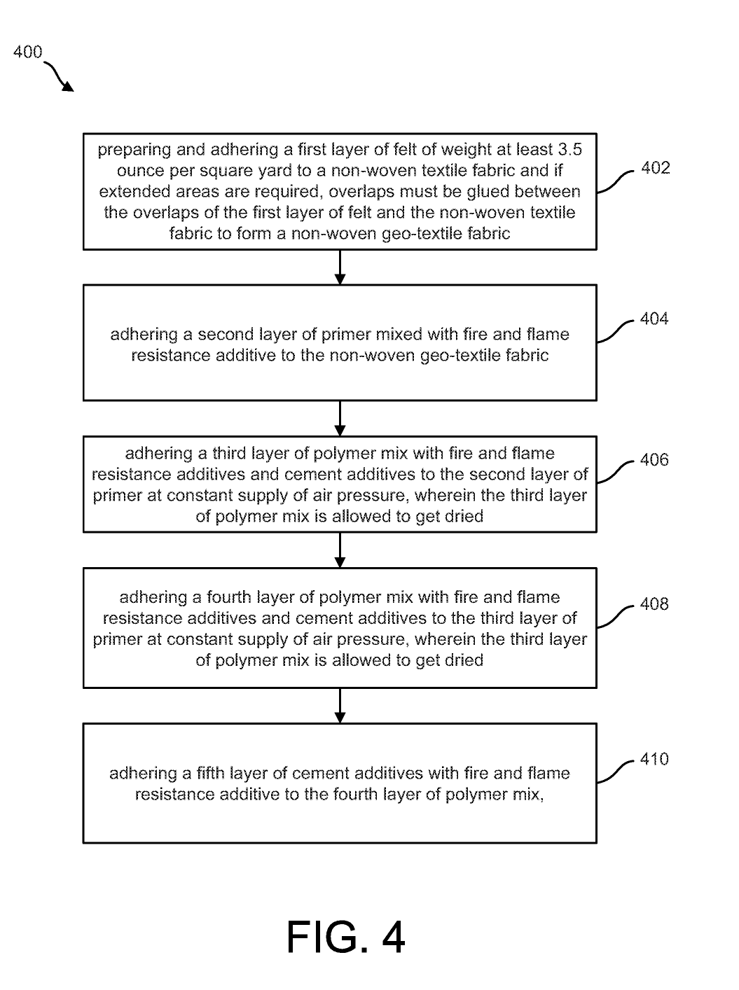

Referring now to FIG. 4, according to another exemplary aspect of the present invention, a method (400) for preparing a waterproof membrane is disclosed. The initial step (102) comprises preparing and adhering a first layer of felt of weight at least 3.5 ounce per square yard to a non-woven textile fabric. Alternatively, the felt alone may define the first layer. If extended areas are required, overlaps are glued between the overlaps of the first layer of felt and the non-woven textile fabric to form a non-woven geo-textile fabric. The next step (404) is to adhere a second layer of primer mixed with a fire and flame resistant additive to the non-woven geo-textile fabric. It should be appreciated that just fire resistant additives or just flame resistant additives or both may be used. Next (406), a third layer of polymer mix with fire and/or flame resistant additives and cement additives is adhered to the second layer of primer preferably using at constant supply of air pressure. The third layer of polymer mix should be allowed to dry before adding the next layer. Next (408), a fourth layer of polymer mix with fire and/or flame resistant additives and cement additives is adhered to the third layer of primer at constant supply of air pressure and allowed to dry. At the next step (410), a top layer, comprising cement additives with fire and/or flame resistant additives, is adhered to the fourth layer of polymer mix. Color pigments can be added to at least one of the primer of two or more of the second layer, polymer mix of the third and fourth layer and additives of the top layer to achieve a desired coloring of the waterproof membrane.

In another aspect, the cement additive comprises calcium cement or portland cement.

In another aspect, the second layer of primer is applied at constant supply of air pressure by applying glue in between the non-woven textile fabric and the felt layer of the non-woven geo-textile fabric.

In another aspect, the waterproof membrane is further added with ceramic granules such as river sand or the like.

Referring back to FIG. 1, another embodiment of a cross sectional view showing different layers of the polymer shingles (100) is presented. The polymer shingles for roofing sheet (100) comprises, a non-woven textile fabric of predetermined configuration coated with a first layer of felt to form a non-woven geo-textile fabric (102). Depending on a specific expected use, this first layer of felt can be added at different thicknesses for achieving desirable strength for the polymer shingles (100). Notably, as before, the non-woven layer may be felt. For one embodiment, the non-woven geo-textile fabric comprises felt of weight at least 3.5 ounce per square yard. A the second layer (104), comprising primer mixed with fire and/or flame resistant additives applied at constant supply of air pressure to adhere the second layer over the non-woven geo-textile fabric (102). Notably, the second layer (104) acts as a bonding layer mechanically associating the non-woven geo-textile fabric (102) with at least one of the third layer (106) and a fourth layer (108). The third layer (106) and the fourth layer (108) each comprise a polymer mixed with fire and flame resistant additives and cement additives adhering over the second layer (104) so that the third layer (106) and the fourth layer (108) define a seal to minimize penetration of water, moisture, light and heat into the polymer shingles (100) thereby defining an all-weather, eco-friendly, UV protecting sheet. A top layer (110) comprising ceramic granules (112), mixed with fire and flame resistant additives and cement additives, where the ceramic granules (112) are bonded to the top layer using a cement additive, is adhered to the fourth layer (108). The granules (112) are preferably compressed with a roller to ingrain the granules (112) in the polymer. Preferably, the granules (112) of the top layer (110) reflect sun light and heat from the surface (shown as arrow marks in FIG. 1) of the shingles thereby attenuating the heat entering into the roofing sheet (100). For one embodiment, color pigments can be added to any one of the primer of the second layer 104, polymer mix of the third and fourth layer (106, 108) and additives of the top layer 110 to achieve a coloring of the polymer shingles for the roofing sheet (100).

As depicted in FIG. 3, in one alternative exemplary embodiment, the polymer shingles also define a waterproof membrane (200). FIG. 2 shows a cross sectional view of the different layers of the polymer shingles (200). The polymer shingles (200) define a waterproof membrane for the roofing sheet and comprises a non-woven geo-textile fabric (202), of predetermined shape and size configuration, wherein the non-woven geo-textile fabric (202) comprises a first layer of felt adhered to a non-woven textile fabric. Notably, the felt may define the first layer. Depending on a consumers' specific needs, the non-woven geo-textile fabric (202) can be added with different thicknesses of felt layer for achieving a desirable strength for the polymer shingles or membrane (200). A second layer (204) comprising primer mixed with fire and/or flame resistant additives is adhered over the non-woven geo-textile fabric (202), wherein the second layer (204) acts as a bonding layer mechanically associating the non-woven geo-textile fabric (202) and a third layer (206). The third and fourth layers (206, 208) comprises a polymer mixed with fire and/or flame resistant additives and cement additives. The third layer (206) is adhered to the second layer (204) and the fourth layer (208) is adhered over the third layer (206), wherein the third layer (206) and fourth layer (208) act as a seal to minimize water/moisture penetrating the polymer shingles (200) thereby creating waterproof or water-resistant membrane. Notably, one may use up to five polymer mixed layers. A top layer (210) comprising cement additives, such as calcium cement and/or portland cement, is associated with the fourth layer. Color pigments are preferably added to at least two of the primer of the second layer (204), the polymer mix of the third and fourth layer (206, 208) and the additives of the top layer (210) so achieve a desired coloring of the waterproof membrane (200).

During manufacturing of the polymer shingles, various layers of the polymer shingles or membrane are preferably allowed to dry at ambient temperature or with a dryer or with a hot air recovery oven or any other method known in the art. The application of polymer and additives should be done with a constant supply of air pressure.

The polymer shingles and/or membrane (100, 200) of the present invention have various advantages over other type of shingles. For example, low input costs of the materials used for preparing the polymer shingles (100, 200) of the present invention translate to lower retail price. Other advantages include environment friendly quality of the polymer shingles (100, 200) that provide high resistant to abrupt changes in weather and temperature conditions as well as their production have the lowest CO2 emission in comparison to other types of shingles, fire resistant, resistant to UV (Ultraviolet) ray exposure, high tensile strength and are highly flexible, resistant to fracture and are easy to repair, resistant to alkaline and acid, longer life span, production simplicity and adaptability to the manufacturing technologies, and to their ease of installation. Further polymer shingles and/or membrane of the present invention are minimally affected, if at all, by expansion or contraction as well as damage due to manhandling. They are highly customizable thus providing varied solutions depending on the quality of the shingle and/or membrane that is required by the market and or customers. The flexible nature of their manufacturing process allows for various components and grading to be changed whilst mostly maintaining their technical performance and their visual appearance.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A roofing sheet comprising:
a non-woven textile fabric that is one of (a) a felt layer and (b) a felt adhered to the non-woven textile fabric to form a non-woven geo-textile fabric;
a second layer comprising primer adhered over the non-woven geo-textile fabric;
a third layer comprising a polymer mixed with cement additives adhered over the second layer; and
a fourth layer comprising a polymer mixed with cement additives adhered over the third layer; and
a top layer adhered to the fourth layer wherein said top layer comprises ceramic granules, wherein the ceramic granules are bonded using said cement additive and wherein the granules are compressed with a roller to ingrain said granules in the polymer of an adjacent layer.

2. A roofing sheet as in claim 1, wherein said primer is mixed with at least one of fire resistant additives and flame resistant additives.

3. A roofing sheet as in claim 2, wherein at least one of said third layer and said fourth layer comprises a polymer further mixed with at least one of fire resistant additives and flame resistant additives.

4. A roofing sheet as in claim 3, wherein said top layer further comprises at least one of fire resistant additives and flame resistant additives.

5. A roofing sheet as in claim 4 wherein color pigments are added to at least one of (a) the primer of the second layer, (b) the polymer mix of the third layer, (c) the polymer mix of fourth layer and (d) the additives of the top layer to define a desired coloring of the roofing sheet.

6. The roofing sheet according to claim 1, wherein the non-woven geo-textile fabric comprises felt of weight at least 3.5 ounce per square yard.

7. The roofing sheet according to claim 1, wherein the second layer of primer is applied at a constant supply of air pressure when the fire and flame resistant additive is added.

8. The roofing sheet according to claim 1, wherein the cement additives comprises at least one of calcium cement and portland cement.

9. A method for preparing a roofing sheet comprising:
preparing and adhering a first layer of felt of weight at least 3.5 ounce per square yard to a non-woven textile fabric to form a non-woven geo-textile fabric;
adhering a second layer of primer mixed with fire and flame resistant additive to the non-woven geo-textile fabric;
adhering a third layer of polymer mix with fire and flame resistant additives and cement additives to the second layer of primer at constant supply of air pressure, wherein the third layer of polymer mix is allowed to dry;
adhering a fourth layer of polymer mix with fire and flame resistant additives and cement additives to the third layer of primer at constant supply of air pressure, wherein the fourth layer of polymer mix is allowed to dry; and
adhering a top layer of ceramic granules on the fourth layer of polymer mix, wherein the ceramic granules are bonded using a cement additive, further the granules are compressed with a roller to ingrain the granules in the fourth layer of polymer mix, further desired color pigments can be added to the primer of the second layer, polymer mix of the third and fourth layer and additives of the top layer to have desired coloring of the roofing sheet.

10. The method according to claim 9, wherein the cement additive comprising calcium cement or portland cement.

11. A waterproof membrane comprising:
a non-woven textile fabric;
a first layer comprising felt adhered to the non-woven textile fabric to form a non-woven geo-textile fabric;
a second layer comprising primer mixed with fire and flame resistant additives adhered over the non-woven geo-textile fabric;
at least one polymer layer comprising a polymer mixed with fire and flame resistant additives and cement additives adhered over the second layer; and
a cover layer comprising cement additives.

12. The waterproof sheet according to claim 11, wherein color pigments are added to at least two of the primer of the second layer, the at least one polymer mix layer, and additives of the cover layer.

13. The waterproof sheet according to claim 11, wherein the non-woven geo-textile fabric comprises felt of weight at least 3.5 ounce per square yard.

14. The waterproof membrane according to claim 11, wherein the second layer of primer plus the fire and flame resistant additives are applied at constant supply of air pressure to the non-woven geo-textile fabric.

15. The waterproof membrane according to claim 11, wherein the cement additive comprises at least one of (a) portland cement mix and (b) calcium cement.

16. A method for preparing a waterproof membrane comprising:
preparing and adhering a first layer of felt of weight at least 3.5 ounce per square yard to a non-woven textile fabric;
adhering a second layer of primer to said non-woven geo-textile fabric, wherein said primer layer is mixed with at least one of fire and flame resistant additives;
adhering polymer section to said second layer of primer wherein said polymer section comprising at least one polymer layer mix comprising at least one of a fire resistant additive, a flame resistant additive and a cement additive;
adhering a top layer to said polymer section wherein said top layer comprises a cement additive and at least one of a fire resistant additive and a flame resistant additive; and
wherein color pigments are added to at least one of the primer of the second layer, the at least one polymer mix layer and the cover layer.

17. The method according to claim 16, wherein the cement additive comprises at least one of (a) portland cement mix and (b) calcium cement mix and wherein the waterproof membrane further comprises ceramic granules to make the shingle more rigid.

18. The method according to claim 17, wherein said ceramic granules comprise one of river sand and rock dust.

19. The method according to claim 16 wherein extended areas for the first layer are defined by glued overlapping sections.

20. The method according to claim 16, wherein the step of adhering layers is performed using at constant supply of air pressure and wherein each layer is allowed to dry before adhering the next layer.
